(19) United States
(12) Patent Application Publication
(10) Pub. No.: US 2023/0271046 A1
(43) Pub. Date: Aug. 31, 2023

(54) FLUORINE-FREE FIREFIGHTING FOAM CONCENTRATES AND FIREFIGHTING FOAM COMPOSITIONS

(71) Applicant: PERIMETER SOLUTIONS LP, Clayton, MO (US)

(72) Inventors: Mark Siem, Suamico, WI (US); Pamela Havelka-Rivard, De Pere, WI (US); LeiLei Zhang, Green Bay, WI (US); Robert Paulick, Green Bay, WI (US); Monica Fernandez, Mieres (ES); Covadonga Perez, Mieres (ES)

(21) Appl. No.: 18/113,808

(22) Filed: Feb. 24, 2023

Related U.S. Application Data
(60) Provisional application No. 63/317,136, filed on Mar. 7, 2022.
(60) Provisional application No. 63/314,117, filed on Feb. 25, 2022.

(51) Int. Cl. A62D 1/02

(52) U.S. Cl. CPC A62D 1/0071

(57) ABSTRACT

The present invention is generally directed to fluorine-free firefighting foam concentrates containing a surfactant component comprising one or more surfactants, optionally one or more solvents, optionally one or more inorganic salts, and optionally one or more organic salts. The present invention is also directed to firefighting foam solutions and firefighting foams prepared from such concentrates and methods for their use. The fluorine-free firefighting foam concentrates exhibit Newtonian behavior. The fluorine-free firefighting foam solution exhibits dilution thickening properties.

### REFERENCE TO RELATED APPLICATIONS

This application claims the benefit of and priority to U.S. Provisional Patent Application Ser. No. 63/314,117, filed Feb. 25, 2022, and U.S. Provisional Patent Application Ser. No. 63/317,136, filed Mar. 7, 2022, the entire disclosures of which are hereby incorporated by reference.

### FIELD OF THE INVENTION

The present invention is generally directed to fluorine-free firefighting foam concentrates containing a surfactant component comprising one or more surfactants, optionally one or more solvents, optionally one or more inorganic salts, and optionally one or more organic salts. The present invention is also directed to firefighting foam solutions and firefighting foams prepared from such concentrates and methods for their use. The fluorine-free firefighting foam concentrates exhibit Newtonian behavior. The fluorine-free firefighting foam solutions exhibit dilution thickening properties.

### BACKGROUND OF THE INVENTION

Aqueous firefighting foams are used against Class-B fires (e.g., fires fueled by flammable liquids). Such firefighting foams include both aqueous film-forming foams (AFFF) and alcohol-resistant aqueous film-forming foams (AR-AFFF). Conventional AFFF and AR-AFFF foams contain fluorine. Due to toxicity, bioaccumulation, and persistence concerns with fluorine, however, in recent years, fluorine-free aqueous firefighting foams have been developed. Suitable fluorine-free foams have been developed that overcome many if not all these issues and concerns identified with fluorine-containing foams. However, areas of improvement exist for such foams.

For example, there exists room for improvement in terms of performance criteria such as, for example, reduced fuel emulsification; applicability for use in a broader range of non-polar and polar fuels; similar performance in fresh, brackish, and salt water (e.g., seawater); and the expanded use in hardware typically used to protect industrial hazards in the petroleum, oil and gas industries.

### BRIEF SUMMARY OF THE INVENTION

Briefly, therefore, the present invention is directed to aqueous firefighting foam concentrates containing a surfactant component containing one or more surfactants, optionally one or more solvents, optionally one or more inorganic salts, and optionally one or more organic salts.

Various aspects of the present invention are directed to firefighting foam concentrates comprising: a solvent selected from the group consisting of alkyl glycols, glycol ethers, and combinations thereof; a surfactant component comprising one or more surfactants selected from the group consisting of sulfate surfactants, branched and/or linear ethoxylated sulfate surfactants, betaine surfactants, sultaine surfactants, amine oxide surfactants, ethoxylated alcohol surfactants, alkylpolyglucoside surfactants, fatty alcohol surfactants, and combinations thereof; optionally, an inorganic salt; and optionally, an organic salt. The viscosity of the firefighting foam concentrate is less than about 200 centipoise (cP); and the viscosity of a firefighting foam solution containing the firefighting foam concentrate and at least 90 wt % water is 10% greater than the viscosity of the firefighting foam concentrate; and/or upon dilution of the firefighting foam concentrate to form a firefighting foam solution, the firefighting foam solution comprises a micellar composition comprising an aqueous phase and a micelle phase comprising surfactant molecules; and/or the firefighting foam concentrate exhibits Newtonian behavior; and/or the firefighting foam solution exhibits solution thickening behavior.

Other aspects of the present invention are directed to firefighting foam concentrates comprising: a surfactant component comprising a C8-C12 sulfate surfactant, a C8-C12 branched and/or linear ethoxylated sulfate surfactant, or a combination thereof; optionally, an inorganic salt; and optionally, an organic salt. The viscosity of the firefighting foam concentrate is less than about 200 centipoise (cP); and the viscosity of a firefighting foam solution containing the firefighting foam concentrate and at least 90 wt % water is 10% greater than the viscosity of the firefighting foam concentrate; and/or upon dilution of the firefighting foam concentrate to form a firefighting foam solution, the firefighting foam solution comprises a micellar composition comprising an aqueous phase and a micelle phase comprising surfactant molecules.

Various other aspects of the present invention are further directed to firefighting foam compositions (e.g., solutions) prepared by diluting any of the concentrates described herein with water, wherein: water constitutes at least about 90 wt % of the composition; and the viscosity of the foam solution is at least about 10% greater than the viscosity of the concentrate diluted to form the composition.

Briefly, therefore, various further aspects of the present invention are directed to firefighting foam compositions prepared from any of the concentrates or solutions described herein, wherein the foam composition exhibits one or more of the following properties under testing in accordance with UL-162: a 25% (quarter) drain time (QDT) of at least about 20 minutes; and/or a saltwater expansion of at least about 3; and/or a saltwater drain time of at least about 20 min; and/or a freshwater expansion of at least about 3; and/or a freshwater drain time of at least about 20 min; and/or an extinguishment of less than about 300 seconds; and/or a burn back of greater than about 300 seconds; and/or passage of the 1^{st} torch test; and/or passage of the 2^{nd} torch test.

Other objects and features will be in part apparent and in part pointed out hereinafter.

### BRIEF DESCRIPTION OF THE SEVERAL VIEWS OF THE DRAWING

FIG. 1 shows quarter drain time (QDT) results as discussed in Example 2.

### DETAILED DESCRIPTION OF THE INVENTION

Described herein are fluorine-free firefighting foam concentrates that exhibit one or more advantageous properties and that provide foam solutions and foam compositions exhibiting one or more advantageous properties.

It is currently believed that firefighting foam concentrates of the present invention exhibit Newtonian viscosity (i.e., viscosity independent of shear rate) and provide a thickening effect upon dilution (i.e., an increase in viscosity). That is, diluted concentrates (e.g., firefighting foam solutions) exhibit higher viscosities than the underlying concentrates (i.e., the firefighting foam solution exhibits solution thickening behavior). This viscosity behavior and the combination(s) of components that provide this behavior are believed to provide firefighting foams that exhibit a myriad of advantageous performance characteristics as detailed herein (e.g., long drain times, etc.). In addition, the viscosity behavior (e.g., water-like properties of the concentrate and foam solution) provide ease in handling and allow for use with existing and/or standard equipment. That is, the current concentrates do not require specialized equipment, which is a significant advantage for users. Moreover, the foam concentrates and solutions of the present invention are suitable for use and provide equivalent performance when used with both fresh water and salt water, another significant advantage for users. The advantageous properties are provided by the particular selection and/or combination of one or more of surfactant(s), and/or solvent(s), and/or inorganic salt(s), and/or organic salt(s).

Generally, the firefighting foam concentrates provide diluted compositions, i.e., solutions that are micellar in that there is an aqueous (bulk) phase having the surfactant molecules and other components distributed throughout. It is currently believed the viscosity behavior of the concentrates and foam solutions and the advantageous and improved performance characteristics for the foam compositions are provided, in part, by the nature of micelle formation within the foam solutions (i.e., a diluted concentrates). These micellar formulations of the foam solutions (diluted concentrates) include structures constructed from the surfactant molecules via a self-assembly mechanism during and/or upon dilution of the concentrate. These micelle structures constructed from the surfactant molecules are believed to be wormlike structures formed from aggregation of the surfactant molecules. In particular, the wormlike structures are believed to be formed from aggregation of surfactant molecules essentially in one direction, lengthwise. The self-assembled micelle structures are believed to function as a dynamic network similar to a polymer solution and display viscoelastic properties upon dilution.

Formation of the self-assembled surfactant micelles upon dilution of the concentrate may be controlled by selection of one or more of the components of the concentrate. One aspect of this selection involves controlling the selection and/or proportion of the components of the concentrates that inhibit self-assembly of the wormlike micelles between the surfactant molecules within the concentrate and prior to dilution.

For example, it is currently believed that one manner of controlling the micelle formation is selection of a solvent and its incorporation within a certain range of concentration. A sufficient proportion of solvent is needed in the concentrate to prevent self-assembly of the surfactant micelles prior to dilution, while also incorporating the solvent at a concentration that results in a sufficiently dilute foam solution that promotes formation of the micellar structures to provide the desired viscosity behavior.

Another method for providing a concentrate that exhibits the desired viscosity behavior and performance upon dilution, while inhibiting self-assembly of the surfactant molecules within the concentrate, is selection of the surfactant(s). For example, as detailed below, various embodiments of the present invention include a surfactant component comprising one or more surfactants selected from the group consisting of sulfate surfactants, branched and/or linear ethoxylated sulfate surfactants, betaine surfactants, sultaine surfactants, ethoxylated alcohol surfactants, alkylpolyglucoside surfactants, and combinations thereof. Other surfactant options are fatty alcohol surfactants.

One option for controlling the self-assembly until dilution of the concentrate is selection of a particular short chain anionic surfactant(s). The ability to control the self-assembly in this manner has been observed to occur even in the absence of a solvent. Accordingly, in various embodiments detailed herein the concentrate comprises one or more particular, short chain anionic surfactants, but does not include a solvent.

A further option for controlling the viscosity properties of the concentrate and self-assembly of the surfactant micelles during and/or after dilution is incorporating an organic salt. Various embodiments of the present invention incorporate an inorganic salt (e.g., a divalent magnesium salt). However, the presence of the inorganic salt could result in an increase in viscosity as compared to concentrates not otherwise including the inorganic salt. To account for this viscosity effect, an organic salt, which has been observed to reduce the concentrate viscosity in certain instances, may be incorporated.

In summary, therefore, the concentrates of the present invention are formulated to provide a desired concentrate viscosity (e.g., less than about 200 centipoise (cP), or “water-like”) and viscosity behavior that results in a thickening effect upon dilution (e.g., providing a firefighting foam solution having a viscosity that is 10%, or more, higher than the viscosity of the concentrate). As detailed herein, this viscosity behavior is provided by a combination of one or more components of the concentrates as discussed herein.

### Foam Concentrates

Generally, the foam concentrates of various aspects of the present invention include a surfactant component comprising one or more surfactants, one or more solvent(s), and optionally one or more inorganic salts and/or one or more organic salts.

It has been discovered that selecting certain combinations of surfactant, solvent, etc. as detailed herein provides compositions that exhibit certain properties that result in properties of the concentrates that provide improved performance. One such property is the viscosity behavior of the concentrate. It has been observed that the viscosity of the concentrate upon dilution increases, thereby providing improved performance characteristics such as drain time. The lower viscosity of the concentrates provides advantages in terms of storage, handling, proportioning, etc. while nonetheless contributing to improved performance characteristics in use.

Typically, the viscosity of the concentrate upon dilution (i.e., after preparing a firefighting foam solution, or foam forming composition prior to aspiration), is at least about 5%, at least about 10%, or at least about 20% greater than the viscosity of the concentrate.

Generally, the viscosity of the concentrates of the present invention is at least about 5 centipoise (cP) or from about 10 cP to about 200 cP. The viscosity of diluted concentrates is typically at least about 10 cP or from about 15 cP to about 400 cP.

Further in accordance with the present invention it has been discovered that the concentrates and other compositions of the present invention may be in the form of a micellar composition comprising a bulk, aqueous phase and a micelle phase comprising surfactant molecules, perhaps in a lamellar or spherical arrangement. It is currently believed that certain components of the concentrate inhibit formation of the wormlike micelles where the surfactant molecules are arranged, or aggregated lengthwise. Dilution of the concentrate to form the firefighting solution conduces formation of these wormlike, lengthwise surfactant molecule arrangement, thereby providing the foam solution exhibiting advantageous properties during storage and handling and advantageous properties during use as a foam (e.g., longer drain times).

Surfactant Component

The surfactant component of the compositions of the present invention generally includes one or more anionic surfactants and one or more amphoteric surfactants.

Suitable anionic surfactants include C8-C22 sulfate surfactants and branched and/or linear ethoxylated C8-C16 sulfate surfactants. In certain embodiments, a C8-C22 sulfate surfactant is the lone anionic surfactant while in other embodiments a branched and/or linear ethoxylated sulfate C8-C16 sulfate surfactant is also included.

Suitable amphoteric surfactants include C8-C22 betaine surfactants and C8-C22 sultaine surfactants.

Suitable amine oxide surfactants include C6-C16 amine oxide surfactants (e.g., alkyl dimethyl amine oxide).

In certain embodiments, a betaine surfactant is included as the lone amphoteric surfactant, while in other embodiments a sultaine surfactant is also included.

In various embodiments, the surfactant component comprises a sulfate surfactant, a branched and/or linear ethoxylated sulfate surfactant, a betaine surfactant, and a sultaine surfactant.

In other embodiments, the surfactant component comprises a sulfate surfactant, a branched and/or linear ethoxylated sulfate surfactant, a betaine surfactant, a sultaine surfactant, an ethoxylated alcohol surfactant and an alkylpolyglucoside surfactant.

In certain embodiments, the surfactant component comprises a sulfate surfactant, a betaine surfactant, and a sultaine surfactant.

Further in accordance with the present invention, the surfactant component may comprise a C8-C12 sulfate surfactant, a C8-C12 branched and/or linear ethoxylated sulfate surfactant, or a combination thereof. In certain of these embodiments, the concentrate does not contain a solvent.

In still further embodiments, the surfactant may include a fatty alcohol surfactant such as, for example, C6 to C16 linear or branched alcohols. Suitable fatty alcohol surfactants include, for example, 3-methyl-3-pentanol (C6), 1-heptanol (enanthic alcohol) (C7), 1-octanol (capryl alcohol) (C8), pelargonic alcohol (1-nonanol) (C9), 1-decanol (decyl alcohol) (C10), undecyl alcohol (1-undecnaol) (C11), lauryl alcohol (dodecanol) (C12), tridecyl alcohol (1-tridecanol) (C13), myristyl alcohol (1-tetradecanol) (C14), pentadecyl alcohol (1-pentadecanol) (C15), cetyl alcohol (1-hexadeconaol) (C16), and combinations thereof.

In accordance with the foregoing and other embodiments, any or all of the surfactants, individually or in combination, may be present in a concentration of at least about 1 wt %, at least about 2 wt %, at least about 3 wt %, at least about 4 wt %, at least about 5 wt %, at least about 10 wt %, at least about 12 wt %, at least about 14 wt %, at least about 15 wt %, or at least about 20 wt %. Additionally, or alternatively, the surfactant(s) may be present in a concentration of less than about 50 wt %, less than about 40 wt %, less than about 30 wt %, less than about 20 wt %, less than about 17 wt %, less than about 16 wt %, less than about 14 wt %, less than about 12 wt %, less than about 8 wt %, less than about 7 wt %, less than about 6 wt %, or less than about 5 wt %. Moreover, any or all of the surfactant(s) may be present within ranges of concentration constructed from any of the listed lower limits in combination with any of the listed upper limits.

The constituents of the surfactant component, or surfactant package may also be selected in combination with the solvent(s) to be incorporated and the optional inorganic salts to provide advantageous performance properties including, for example, quarter drain time.

Solvent(s)

Suitable solvents include glycols, including alkyl glycols, glycol ethers, and combinations thereof. Typically, a minimum proportion of the solvent is included to provide a thinning effect on the viscosity of the concentrate to allow for the dilution thickening effect on the viscosity of the diluted concentrate while nonetheless providing a concentrate with desired viscosity properties for preparation, handling, storage, etc. Suitable glycol solvents, including alkyl glycols include C2-C10 glycols, C4-C8 glycols and C6-C8 glycols. In certain embodiments where the solvent comprises a glycol, the solvent comprises or consists essentially of hexylene glycol (2-methylpentane-2,4-diol). In still other embodiments where the solvent comprises a glycol, the solvent comprises or consists essentially of methyl propanediol (2-methyl-1,3-propanediol). Suitable glycol ether solvents include C3-C10 glycol ethers, including C6-C10 glycol ethers. One example of a suitable glycol ether solvent is butyl CARBITOL (diethylene glycol monobutyl ether).

Typically, the solvent is present in the concentrate in a proportion of at least about 0.1 wt %, at least about 0.5 wt %, at least about 1 wt %, at least about 2 wt %, at least about 3 wt %, or at least about 4 wt %. Generally, the solvent is present in a proportion of from about 0.1 wt % to about 14 wt % (e.g., from about 0.1 wt % to about 10 wt %), from about 2 wt % to about 14 wt % (e.g., from about 3 wt % to about 10 wt %, from about 4 wt % to about 10 wt %, from about 5 wt % to about 8 wt %, or from about 4 wt % to about 12 wt %).

In addition to the embodiments containing one or more solvent(s) in accordance with the foregoing, various embodiments of the present invention do not include any solvent. For example, in certain embodiments the surfactant selected (e.g., a short-chain surfactant) is believed, at least in part, to provide the desired viscosity (i.e., Newtonian behavior).

Inorganic Salts

Suitable inorganic salts include mono-valent and di-valent salts. Suitable inorganic salts include sodium sulfate, sodium chloride, magnesium sulfate, magnesium nitrate, magnesium chloride, calcium chloride, and combinations thereof. In certain embodiments, the inorganic salt is a mono-valent salt selected from sodium sulfate, sodium chloride, and combinations thereof. In other embodiments, the inorganic salt is a di-valent salt selected from magnesium sulfate, magnesium nitrate, magnesium chloride, calcium chloride, and combinations thereof. In various embodiments, the inorganic salt is the di-valent salt magnesium sulfate.

Typically, any inorganic salt is present in the concentrate in a proportion of up to about 10 wt %, up to about 18.5 wt %, up to about 20 wt %, or up to about 25 wt % (e.g., from about 5 wt % to about 20 wt % (e.g., from about 5 wt % to about 10 wt %), from about 10 wt % to about 20 wt %, from about 10 wt % to about 14 wt %, from about 15 wt % to about 20 wt %, from about 16.5 wt % to about 18.5 wt %, or from about 17 wt % to about 25 wt %). In certain embodiments, the inorganic salt is present in a proportion of at least about 0.1 wt %, at least about 1 wt %, at least about 3 wt % or at least about 10 wt %.

Organic Salts

Suitable organic salts include, for example, acetate salts, citrate salts, amine salts (e.g., salts of triethanolamine (TEA)), carboxylic acid salts (e.g., salts of ethylenediaminetetraacetic acid (EDTA)), and combinations thereof.

Any organic salt is typically included in a proportion at least about 0.7 wt %, and/or up to about 5 wt %.

Additional Components

The foam concentrates typically contain from about 10 wt % to about 80 wt % water, or from about 15 wt % to about 45 wt % water.

### Foam Solutions

Typically, foam solutions of the present invention contain at least or about 0.5 wt %, 1 wt %, 2 wt %, 3 wt %, 4 wt %, 5 wt %, or 6 wt % of the foam concentrate. That is, the foam solutions are typically prepared from the foam concentrate by dilution with water at a dilution ratio (concentrate:water) of from 1:99 to 6:94.

As discussed above, the foam solutions of the present invention exhibit dilution-thickening as compared to the underlying foam concentrate. This is currently believed to be due to the formation of wormlike (i.e., lengthwise) micellar structures formed from surfactant molecules. These aggregations of surfactant molecules contained in the solution following dilution of the concentrate are believed to provide advantageous performance properties for the solutions and foams prepared therefrom.

Typically, the viscosity of the concentrate upon dilution (i.e., after preparing a firefighting foam solution, or foam forming composition prior to aspiration), is at least about 5%, at least about 10%, or at least about 20% greater than the viscosity of the concentrate. Additionally, or alternatively, the viscosity of the foam solution is typically at least about 200 cP, at least about 210 cP, at least about 220 cP, at least about 230 cP, at least about 240 cP, or at least about 250 cP.

### Foams

Generally, the foams of the present invention are prepared by aspirating a foam solution of the present invention. Advantageously, the foams of the present invention are suitable for use with low expansion foam equipment and medium and high expansion foam discharge devices.

Foams of the present invention exhibit one or more advantageous properties in use and/or provide one or more efficiencies. In particular, the performance achieved within the ranges below may exceed those provided by earlier foams. For example, longer drain times have been observed for the current foams as compared to fluorinated foams. By way of further example, suitable performance for the properties detailed below are provided while the foams are suitable for use with standard equipment and with any suitable water source (i.e., the end user does not need to be concerned whether fresh or saltwater is to be used).

Foams of the present invention are currently believed to at least meet, if not exceed performance standards known in the art including for example, military specifications (i.e., MilSpec, including Mil-F-24385 and Mil-PRF-XX727 (“XX”=to de determined)), ICAO (e.g., level C performance), EN-1568, LASTFIRE, IMO, FM, land based operations standards, and/or sea operations standards.

Additionally, or alternatively, foams of the present invention exhibit the following properties when subjected to testing methods known in the art, in particular UL-162:
a 25% (quarter) drain time (QDT) of at least about 20 minutes (e.g., from 20 minutes to 120 minutes); and/or
an Expansion Ratio of from 12:1 to 3:1; and/or
a salt water expansion of at least about 3; and/or
a salt water drain time of at least about 900 seconds, 1000 seconds or 1200 seconds; and/or
a fresh water expansion of at least about 3; and/or
a fresh water drain time of at least about 900 seconds, 1000 seconds, or 1200 seconds; and/or
an extinguishment of less than about 300 seconds (e.g., from about 120 seconds to about 300 seconds); and/or
a burn back of greater than about 300 seconds; and/or
passage of the 1^{st} torch test; and/or
passage of the 2^{nd} torch test.

### Methods for Fighting Fires

The compositions and foams of the present invention are suitable for use in methods for combatting and/or extinguishing a Class-B fire where a composition or foam composition is applied directly or indirectly onto a Class-B fire or the fuel ahead of a potentially advancing Class-B fire front.

In addition, embodiments of the present invention are currently believed to be suitable as Class-A foams. Class-A foams increase the effectiveness of water for direct suppression and mop up and can be used in both aerial and ground operations. It is further currently believed that certain embodiments of the present invention are suitable as Class-A/B foams, in particular fluorine-free Class-A/B foams. Class A/B foam can be used in multiple applications ranging from structural and residential fires; wildland fires; general facilities protection; Class A hazards (ordinary combustible materials such as wood, cloth, paper, rubber, and many plastics); Class B hazards that are not fuel in depth; (e.g., vehicle fires) and foam training exercises. Thus, various embodiments of the present invention are directed to firefighting foam concentrates suitable for use in forming Class-A and/or Class-A/B foams and the foams produced from such concentrates.

Having described the invention in detail, it will be apparent that modifications and variations are possible without departing from the scope of the invention defined in the appended claims.

### EXAMPLES

The following non-limiting examples are provided to further illustrate the present invention.

### Example 1

The following example describes compositions suitable for use in firefighting foam compositions, including formulations suitable for use at a concentration in water of 1-3 wt %.

The following table lists the components of the formulations and exemplary ranges for their concentrations:

| Generic Identifier | Chemical Name | Levels |
|---|---|---|
| Branched and/or | Alcohols, C9-11, Branched | 2 < x < 7% |
| Linear Ethoxylated | And Linear, ethoxylated, | |
| Sulfate | Sulfates, Sodium Salts | |
| Betaine | 1-Propanaminium, N- | Total: |
| | (carboxymethyl)-N,N- | 10 < x < 40% |
| | dimethyl-3-[(1- | (e.g., equal |
| | oxododecyl)amino]-, inner | wt. % to |
| | salt | sultaine) |
| Sultaine | 1-Propanaminium, 2- | 10 < x < 40% |
| | hydroxy-N,N-dimethyl-N- | (e.g., equal |
| | [3-[(1- | wt. % to |
| | oxododecyl)amino]propyl]- | betaine) |
| | 3-sulfo-, inner salt | |
| Linear Sulfate | Sodium dodecyl Sulfate | 10 < x < 14% |
| Solvent | 2-Methyl-2,4-pentanediol | 4 < x < 12% |
| Inorganic Salt | Magnesium Sulfate | >10% |
| | Heptahydrate | |
| Organic Salt | Tri ethanol amine | 0.7% < x < 5% |
| Water | Water | |

Formulations 1-7 shown in the following table were subjected to the following tests with the results also shown in the following table:

UL-162: Expansion Ratio (ratio of finished foam volume to original foam solution volume)

UL-162: 25% Drain Time (sec) (time for 25% of the foam solution to drain from the finished foam)

UL-162: Extinguishment (sec) (point at which no flames are present during foam application)

UL-162: Burn Back (sec) (point during the test at which the foam blanket is exposed to a flame via a removable sleeve. The burning area does not exceed 20% of the fire test pan surface.

| | 1 | 2 | 3 | 4 | 5 | 6 | 7 |
|---|---|---|---|---|---|---|---|
| Brch. and/or Lin. Eth. | 8.01 | 8.01 | 5.5 | 8.01 | 5.27 | 10.53 | 5.72 |
| Sulfate | | | | | | | |
| Betaine | 9.48 | 9.48 | 6.75 | 9.48 | 9.48 | 18.95 | 15.02 |
| Sultaine | 9.48 | 9.48 | 6.75 | 9.48 | 6.66 | 13.27 | 15.02 |
| Lin. Sulfate | 7.31 | 7.31 | 3.5 | 7.31 | 5.27 | 10.53 | 11.58 |
| Solvent | 6.62 | | 5.00 | 6.62 | 6.62 | 13.23 | 9.44 |
| Solvent 2 | | 6.62 | | | | | |
| Inorganic Salt | 4.00 | 4.00 | 5.00 | | 2.00 | 4 | 19.50 |
| Water | To 100 | To 100 | To 100 | To 100 | To 100 | To 100 | To 100 |
| UL-162: Expansion | 6.87 | 6.60 | 6.41 | 6.81 | 6.7 | 7.07 | 7.31 |
| UL-162: 25% Drain Time | 535 | 586 | 205 | 450 | 483 | 554 | 1466 |
| (sec) | | | | | | | |
| UL-162: Extinguishment | 270 | 274 | 168 | 345 | 336 | 258 | 180 |
| (sec) | | | | | | | |
| UL-162: Burn Back (sec) | 85 | 45 | N/A¹ | 60 | 58 | N/A¹ | 330 |

### Example 2

The following example describes compositions suitable for use in firefighting foam compositions, including formulations suitable for use at a concentration in water of, for example, 3 wt %. These formulations exemplify incorporating one or more nonionic surfactants (e.g., an ethoxylated alcohol or an alkylpolyglucoside (APG)). These compositions also exemplify the possibility of an organic salt.

The following table lists the components of the formulations and exemplary ranges for their concentrations:

| Composition | Levels |
|---|---|
| Branched and/or Linear | 2 < x < 7% |
| Ethoxylated Sulfate Surfactant | |
| Betaine Surfactant | Equal wt. % to |
| | sultaine |
| | Total: |
| | 5 < x < 30% |
| Sultaine Surfactant | Equal wt. % to |
| | betaine |
| | Total: |
| | 5 < x < 30% |
| Sulfate Surfactant | 2 < x < 12% |
| Glycol and/or glycol ether | 2 < x < 14% |
| Ethoxylated Alcohols | 0 < x < 5% |
| Alkylpolyglucosides | 0 < x < 5% |
| Inorganic Salt | >10% |
| Organic Salt | 0.7% < x < 5% |

Formulations 1-4 shown in the following table were subjected to the following tests with the results also shown in the following table:

In addition to the above testing, formulations were selected to the following tests:

UL-162 Topside: Extinguishment (sec)

UL-162 Topside: 1^{st} torch test (Pass/Fail)

UL-162 Topside: 2^{nd} torch test (Pass/Fail)

UL-162: Burnback (sec)

| | 1 | 2 | 3 | 4 |
|---|---|---|---|---|
| Brch. and/or Lin. | 3.0 | 3.90 | 3.26 | 3.26 |
| Eth. Sulfate | | | | |
| Betaine surfactant | 8.0 | 8.0 | 11.97 | 11.97 |
| Sultaine surfactant | 8.0 | 8.0 | 11.97 | 11.97 |
| Sulfate surfactant(s) | 4.6 | 4.6 | 8.79 | 8.79 |
| Solvent 1 | 10 | 10 | | |
| Solvent 2 | | | 8.47 | 8.47 |
| Solvent 3 | | | 4.55 | 4.55 |
| Inorganic Salt | | | | 10 |
| Water | To 100 | To 100 | To 100 | To 100 |
| Foam Expansion Ratio | 7.75 | 7.86 | 7.16 | 6.69 |
| 25% Drain Time (sec) | 215 | 165 | 870 | 1560 |
| UL Topside: | 360 | 165 | 94 | 94 |
| Extinguishment (sec) | | | | |
| UL Topside: 1^{st} torch | No test | Pass | Pass | Pass |
| test | | | | |
| UL Topside: 2^{nd} torch | Foam opened | Fail | Pass | Pass |
| test | at 510 sec | | | |
| UL Topside: Burnback | | | Fire | 20% |
| | | | spread | burning |
| | | | before | after |
| | | | pulling | pulling |
| | | | sleeve | sleeve |

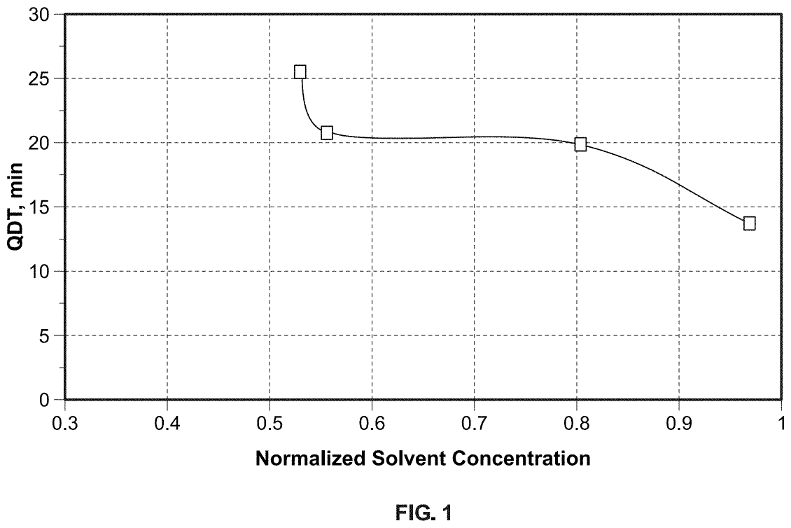

FIG. 1 shows a graph of quarter drain time (QDT) versus normalized solvent concentration.

As shown in the FIG., QDT can be controlled by the level of solvent or short chain surfactants utilized. This is currently believed to be due to the impact of the solvent on surfactant assembly. As solvent level decreases, surfactant assembly is disrupted, which in this testing is shown to be accompanied by an increase in QDT.

### Example 3

The following table provides exemplary compositions for fluorine-free firefighting foam concentrates. The concentrates are suitable for preparation of foams at concentrations diluted to 1% through 6% foam concentrate with from 99% to 94% water, respectively. The compositions are useful for use in connection with class-B non-polar fuels.

| Type | Composition | Formulation 1 | Formulation 2 | Formulation 3 | Formulation 4 | Formulation 5 | Formulation 6 |
|---|---|---|---|---|---|---|---|
| Solvent | Glycol and/or glycol | 3%-10% | 3%-10% | 4%-12% | 2%-14% | 3%-10% | 3%-10% |
| | ether | | | | | | |
| Anionic | Sulfate Surfactant | 10%-50% | 10-50% | 10%-20% | 2%-12% | 5%-30% | 5%-30 |
| | (C8-C22) | | | | | | |
| | Branched and/or | | | | 1%-7% | | |
| | Linear | | | | | | |
| | Ethoxylated Sulfate | | | | | | |
| | Surfactant | | | | | | |
| | (C8-C16) | | | | | | |
| Amphoteric | Betaine Surfactant | 5%-50% | | 5%-40% | 5%-30% | | 5%-30% |
| | (C8-C22) | | | | | | |
| | Sultaine Surfactant | | 15%-50% | 10%-40% | 5%-30% | | |
| | (C8-C22) | | | | | | |
| | Amine Oxide | | | | | 5%-30% | |
| | Surfactant | | | | | | |
| | (C6-C16) | | | | | | |
| Inorganic Salt | Inorganic Salt | | >3% | >10% | 0%-25% | | 0%-25% |
| Fatty Alcohol | Linear and/or | | | | | 0%-5% | 0%-5% |
| | Branched Alcohol | | | | | | |
| | (C6-C16) | | | | | | |

### Example 4

This example describes formulations containing each of a betaine surfactant, a sultaine surfactant, a branched and/or linear ethoxylated sulfate surfactant, and a sulfate surfactant, at varying concentrations of sulfate surfactant. As shown, the concentration of sulfate surfactant directly impacted the freshwater and saltwater drain times.

The concentration of sulfate surfactant also directly impacts the freshwater and saltwater drain times for formulations also containing (i) a sultaine surfactant and (ii) a betaine surfactant and sultaine surfactant.

| Type | | 5-1 | 5-2 | 5-11 | 5-3 |
|---|---|---|---|---|---|
| Amphoteric | Betaine Surfactant | 15.02 | 15.02 | 15.02 | 15.02 |
| | Sultaine Surfactant | 15.02 | 15.02 | 15.02 | 15.02 |
| Anionic | Branched and/or | 5.72 | 5.72 | 5.72 | 5.72 |
| | Linear Ethoxylated | | | | |
| | Sulfate Surfactant | | | | |
| | Sulfate Surfactant | 11.58 | 12.50 | 12.75 | 13.50 |
| Solvent | Glycol and/or glycol | 9 | 9 | 9 | 9 |
| | ether | | | | |
| Inorganic | Inorganic Salt | 19.5 | 19.5 | 19.5 | 19.5 |
| Salt | | | | | |
| | Water | 24.16 | 23.24 | 22.99 | 22.24 |
| | Saltwater Expansion | 5.3 | 5.2 | 5.4 | 5.1 |
| | Saltwater Drain | 1476 | 1885 | 1131 | 855 |
| | Time (s) | | | | |
| | Fresh Water | 6 | 5.5 | 5.5 | 5.5 |
| | Expansion | | | | |
| | Fresh Water Drain | 717 | 913 | 996 | 1240 |
| | Time (s) | | | | |

### Example 5

This example describes formulations containing each of a betaine surfactant, a sultaine surfactant, a branched and/or linear ethoxylated sulfate surfactant, and a sulfate surfactant, along with an inorganic salt at varying concentrations of the inorganic salt.

| | 5-4 | 5-5 | 5-6 |
|---|---|---|---|
| Branched and/or Linear | 5.72 | 5.72 | 5.72 |
| Ethoxylated Sulfate | | | |
| Surfactant | | | |
| Betaine Surfactant | 15.02 | 15.02 | 15.02 |
| Sultaine Surfactant | 15.02 | 15.02 | 15.02 |
| Sulfate Surfactant | 11.58 | 11.58 | 11.58 |
| Glycol and/or glycol | 9 | 9 | 9 |
| ether | | | |
| Inorganic Salt | 18.5 | 17.5 | 16.5 |
| Water | 25.16 | 26.16 | 27.16 |
| Salt water Expansion | 5.2 | 5.3 | 5.1 |
| Salt water Drain Time | 1415 | 1338 | 1398 |
| (s) | | | |
| Fresh water Expansion | 5.5 | 6.4 | 5.8 |
| Fresh water Drain Time | 799 | 567 | 526 |
| (s) | | | |

### Example 6

This example describes results for formulations including a betaine surfactant, a sultaine surfactant, and a sulfate surfactant. As shown in the results, the concentration of betaine surfactant impacts the saltwater drain times. The fresh water and salt water drain times each reached their maximum at approximately 17-19 wt % betaine surfactant.

| | 26-1-1 | 26 | 26-1-2 |
|---|---|---|---|
| Betaine Surfactant | 15.04 | 17.04 | 19.04 |
| Sultaine Surfactant | 17.04 | 17.04 | 17.04 |
| Sulfate Surfactant | 14.52 | 14.52 | 14.52 |
| Glycol and/or glycol | 6 | 6 | 6 |
| ether | | | |
| Inorganic Salt | 20 | 20 | 20 |
| Water | 27.40 | 25.40 | 23.40 |
| Salt water Expansion | 4.5 | 4.7 | 4.7 |
| Salt water Drain Time | 1205 | 2137 | 1943 |
| (s) | | | |
| Fresh water Expansion | 4.9 | 5.1 | 4.9 |
| Fresh water Drain | 2515 | 2561 | 1708 |
| Time(s) | | | |

### Example 7

This example describes results for formulations containing a betaine surfactant, a sultaine surfactant, and a sulfate surfactant. The results indicate an increase in the solvent concentration correlates with an increase in saltwater drain time.

| | 42-4 | 42-5 | 42-16 | 42-17 | 42-18 |
|---|---|---|---|---|---|
| Betaine Surfactant | 16 | 16 | 16 | 16 | 16 |
| Sultaine Surfactant | 18.5 | 18.5 | 18.5 | 18.5 | 18.5 |
| Sulfate Surfactant | 15.5 | 15.5 | 15.5 | 15.5 | 15.5 |
| Glycol and/or glycol | 4 | 5 | 6 | 7 | 8 |
| ether | | | | | |
| Inorganic Salt | 20 | 20 | 20 | 20 | 20 |
| Water | 26 | 25 | 24 | 23 | 22 |
| Salt water Expansion | 4.7 | 5.0 | 5.2 | 6.2 | 6.3 |
| Salt water Drain Time | 995 | 1590 | 2355 | 2364 | 2632 |
| (s) | | | | | |
| Fresh water Expansion | 5 | 5.5 | 5.3 | 5.6 | 5.9 |
| Fresh water Drain Time | 2463 | 2711 | 2704 | 2407 | 2550 |
| (s) | | | | | |

### EMBODIMENTS

Embodiment A is directed to a firefighting foam concentrate, the concentrate comprising: a solvent selected from the group consisting of alkyl glycols, glycol ethers, and combinations thereof; a surfactant component comprising one or more surfactants selected from the group consisting of sulfate surfactants, branched and/or linear ethoxylated sulfate surfactants, betaine surfactants, amine oxide surfactants, sultaine surfactants, ethoxylated alcohol surfactants, linear and/or branched C6-C16 alcohols, alkylpolyglucoside surfactants, and combinations thereof; optionally, an inorganic salt; and optionally, an organic salt; wherein: the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate, the viscosity determined using a Brookfield viscometer using spindle #4 at 30 revolutions per minute (rpm); and/or upon dilution of the firefighting foam concentrate to form a firefighting foam solution, the firefighting foam solution comprises a micellar composition comprising an aqueous phase and a micelle phase comprising surfactant molecules; and/or the firefighting foam concentrate exhibits Newtonian behavior; and/or the firefighting foam solution exhibits solution thickening behavior.

Embodiment A1 is the firefighting foam concentrate of Embodiment A, the concentrate comprising: a surfactant component comprising a sulfate surfactant, a branched and/or linear ethoxylated sulfate surfactant, a betaine surfactant, amine oxide surfactant and a sultaine surfactant.

Embodiment A2 is the firefighting foam concentrate of Embodiment A1, the concentrate comprising a solvent, wherein the solvent is present in a concentration of at least about 0.1 wt %, or from about 0.1 wt % to about 10 wt %.

Embodiment A3 is the firefighting foam concentrate of Embodiment A1 or A2, wherein the concentrate comprises an inorganic salt selected from the group consisting of magnesium sulfate, magnesium nitrate, magnesium chloride, calcium chloride, and combinations thereof.

Embodiment A4 is the firefighting foam concentrate of Embodiment A3, wherein the inorganic salt is present in a concentration of at least about 10 wt %.

Embodiment A5 is the firefighting foam concentrate of Embodiment A1, wherein the sulfate surfactant is present in a concentration of at least about 10 wt %, or from about 10 wt % to about 14 wt %.

Embodiment A6 is the firefighting foam concentrate of Embodiment A5, wherein a firefighting foam solution containing the firefighting foam concentrate and at least 90 wt %. water exhibits a fresh water drain time of at least 900 seconds and a salt water drain time of at least 900 seconds.

Embodiment A7 is the firefighting foam concentrate of Embodiment A, the concentrate comprising an inorganic salt selected from the group consisting of sodium sulfate, sodium chloride, magnesium sulfate, magnesium nitrate, magnesium chloride, calcium chloride, and combinations thereof, wherein the inorganic salt is present in a concentration of from about 5 wt % to about 20 wt %, or from about 16.5 wt % to about 18.5 wt %.

Embodiment A8 is the firefighting foam concentrate of Embodiment A, the concentrate comprising: a sulfate surfactant, a branched and/or linear ethoxylated sulfate surfactant, a betaine surfactant, a sultaine surfactant, linear and/or branched fatty alcohol, an ethoxylated alcohol surfactant and an alkylpolyglucoside surfactant.

Embodiment A9 is the firefighting foam concentrate of Embodiment A8, wherein the solvent is present in a concentration of from about 0.1 wt % to about 15 wt %, from about 4 wt % to about 10 wt %.

Embodiment A10 is the firefighting foam concentration of Embodiment A8 or A9, wherein the concentrate comprises an inorganic salt selected from the group consisting of magnesium sulfate, magnesium nitrate, magnesium chloride, calcium chloride, and combinations thereof.

Embodiment A11 is the firefighting foam concentrate of Embodiment A, the concentrate comprising: a solvent selected from the group consisting of glycols (e.g., hexylene glycol (2-methylpentane-2,4-diol) and/or methyl propanediol (2-methyl-1,3-propanediol)), alkyl glycols, glycol ethers (e.g., diethylene glycol monobutyl ether), and combinations thereof; and an anionic sulfate surfactant and an amphoteric betaine surfactant.

Embodiment A12 is the firefighting foam concentrate of Embodiment A11, wherein the sulfate surfactant is present at a concentration of from about 5 wt % to about 50 wt %, or from about 10 wt % to about 30 wt %.

Embodiment A13 is the firefighting foam concentrate of Embodiment A11 or A12, wherein the betaine surfactant is present at a concentration of from about 5 wt % to about 50 wt %, or from about 5 wt % to about 30 wt %.

Embodiment A14 is the firefighting foam concentrate of any one of Embodiments A11 to A13, wherein the solvent is present at a concentration of from about 1 wt % to about 15 wt %, or from about 3 wt % to about 10 wt %.

Embodiment A15 is the firefighting foam concentrate of Embodiment A, the concentrate comprising; a solvent selected from the group consisting of alkyl glycols, glycol ethers, and combinations thereof; an anionic sulfate surfactant and an amphoteric surfactant selected from a betaine surfactant, sultaine surfactant, or a combination thereof; and an inorganic di-valent salt selected from the group consisting of magnesium nitrate, magnesium chloride, magnesium sulfate, calcium chloride, and combinations thereof.

Embodiment A16 is the firefighting foam concentrate of Embodiment A15, wherein water is present in a concentration of from about 10 wt % to about 80 wt %, or from about 15 wt % to about 45 wt %.

Embodiment A17 is the firefighting foam concentrate of Embodiment A15 or A16, wherein the surfactant component comprises an anionic sulfate surfactant and an amphoteric sultaine surfactant.

Embodiment A18 is the firefighting foam concentrate of Embodiment A17, wherein the sulfate surfactant is present at a concentration of from about 5 wt % to about 50 wt %, or from about 10 wt % to about 30 wt %.

Embodiment A19 is the firefighting foam concentrate of Embodiment A17 or A18, wherein the sultaine surfactant is present at a concentration of from about 15 wt % to about 50 wt %, or from about 20 wt % to about 30 wt %.

Embodiment A20 is the firefighting foam concentrate of any of Embodiments A15 to A19, wherein the solvent is present at a concentration of from about 3 wt % to about 10 wt %, or from about 5 wt % to about 8 wt %.

Embodiment A21 is the firefighting foam concentrate of Embodiments A15 to A20, wherein the inorganic salt is present at a concentration of at least about 0.1 wt. %, or from about 10 wt % to about 30 wt %.

Embodiment A22 is the firefighting foam concentrate of Embodiment A15, the concentrate comprising: an anionic sulfate surfactant and an amphoteric surfactant comprising a betaine surfactant and a sultaine surfactant.

Embodiment A23 is the firefighting foam concentrate of Embodiment A22, wherein the sulfate surfactant is present at a concentration of from about 10 wt % to about 20 wt %, or from about 14 wt % to about 17 wt %.

Embodiment A24 is the firefighting foam concentrate of Embodiment A22 or A23, wherein the betaine surfactant is present at a concentration of from about 5 wt % to about 40 wt %, or from about 12 wt % to about 20 wt %.

Embodiment A25 is the firefighting foam concentrate of any of Embodiments A22 to A24, wherein the sultaine surfactant is present at a concentration of from about 10 wt % to about 40 wt %, or from about 12 wt % to about 20 wt %.

Embodiment A26 is the firefighting foam concentrate of Embodiments A22 to A25, wherein the solvent is present at a concentration of from about 4 wt % to about 12 wt %, or from about 5 wt % to about 8 wt %.

Embodiment A27 is the firefighting foam concentrate of any of Embodiments A22 to A26, wherein the inorganic salt is present at a concentration of at least about 10 wt %, or from about 17 wt % to about 25 wt %.

Embodiment A28 is the firefighting foam concentrate of Embodiment A15, the concentrate comprising: a sulfate surfactant, a branched and/or linear ethoxylated sulfate surfactant, a betaine surfactant, and a sultaine surfactant.

Embodiment A29 is the firefighting foam concentrate of Embodiment A28, wherein the sulfate surfactant is present in a concentration of from about 2 wt % to about 12 wt %, or from about 4 wt % to about 8 wt %.

Embodiment A30 is the firefighting foam concentrate of Embodiment A28 or A29, wherein the branched and/or linear ethoxylated sulfate surfactant is present in a concentration of from about 1 wt % to about 7 wt %, or from about 3 wt % to about 6 wt %.

Embodiment A31 is the firefighting foam concentrate of any of Embodiments A28 to A30, wherein the betaine surfactant and sultaine surfactant are present in a concentration of from about 5 wt % to about 30 wt %, or from about 10 wt % to about 16 wt %.

Embodiment A32 is the firefighting foam concentrate of any of Embodiments A28 to A31, wherein the inorganic salt is present in a concentration of up to about 25 wt %, or from about 10 wt % to about 20 wt %.

Embodiment A33 is the firefighting foam concentrate of Embodiment A15, the concentrate comprising: a sulfate surfactant, a betaine surfactant, and a sultaine surfactant, wherein the betaine surfactant is present in a concentration of at least about 5 wt %, or from about 10 wt % to about 30 wt %.

Embodiment A34 is the firefighting foam concentrate of Embodiment A33, wherein a firefighting foam solution containing the firefighting foam concentrate and at least 90 wt % water exhibits a fresh water drain time of at least 900 seconds, or at least 1000 seconds and a salt water drain time of at least 900 seconds, or at least 1000 seconds.

Embodiment A35 is the firefighting foam concentrate of Embodiment A34, the concentrate comprising: a solvent selected from the group consisting of alkyl glycols, glycol ethers, and combinations thereof, wherein the solvent is present in a concentration of at least about 0.1 wt %, or from about 4 wt % to about 8 wt %; and a sulfate surfactant, a betaine surfactant, and a sultaine surfactant.

Embodiment A36 is the firefighting foam concentrate of Embodiment A35, wherein a firefighting foam solution containing the firefighting foam concentrate and at least 90 wt % water exhibits a fresh water drain time of at least 900 seconds, or at least 1000 seconds and a salt water drain time of at least 900 seconds, or at least 1000 seconds.

Embodiment B is directed to a firefighting foam concentrate, the concentrate comprising: a surfactant component comprising a C8-C12 sulfate surfactant, a C8-C12 branched and/or linear ethoxylated sulfate surfactant, or a combination thereof; optionally, an inorganic salt; and optionally, an organic salt, wherein: the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or upon dilution of the firefighting foam concentrate to form a firefighting foam solution, the firefighting foam solution comprises a micellar composition comprising an aqueous phase and a micelle phase comprising surfactant molecules and/or the firefighting foam concentrate exhibits Newtonian behavior; and/or the firefighting foam solution exhibits solution thickening behavior.

Embodiment C is directed to a firefighting foam concentrate, the concentrate comprising: a solvent selected from the group consisting of alkyl glycols, glycol ethers, and combinations thereof; a surfactant component comprising a C6-C16 amine oxide surfactant; optionally, an inorganic salt; and optionally, an organic salt; wherein: the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or upon dilution of the firefighting foam concentrate to form a firefighting foam solution, the firefighting foam solution comprises a micellar composition comprising an aqueous phase and a micelle phase comprising surfactant molecules; and/or the firefighting foam concentrate exhibits Newtonian behavior; and/or the firefighting foam solution exhibits solution thickening behavior.

Embodiment D is directed to a firefighting foam concentrate, the concentrate comprising: a solvent selected from the group consisting of alkyl glycols, glycol ethers, and combinations thereof; a surfactant component comprising a C6-C16 linear or branched fatty alcohol surfactant; optionally, an inorganic salt; and optionally, an organic salt; wherein: the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or upon dilution of the firefighting foam concentrate to form a firefighting foam solution, the firefighting foam solution comprises a micellar composition comprising an aqueous phase and a micelle phase comprising surfactant molecules; and/or the firefighting foam concentrate exhibits Newtonian behavior; and/or the firefighting foam solution exhibits solution thickening behavior.

Embodiment D1 is directed to a firefighting foam concentrate of Embodiment D wherein the surfactant is a C6 to C16 linear or branched alcohol selected from the group consisting of 3-methyl-3-pentanol (C6), 1-heptanol (enanthic alcohol) (C7), 1-octanol (capryl alcohol) (C8), pelargonic alcohol (1-nonanol) (C9), 1-decanol (decyl alcohol) (C10), undecyl alcohol (1-undecnaol) (C11), lauryl alcohol (dodecanol) (C12), tridecyl alcohol (1-tridecanol) (C13), myristyl alcohol (1-tetradecanol) (C14), pentadecyl alcohol (1-pentadecanol) (C15), cetyl alcohol (1-hexadeconaol) (C16), and combinations thereof.

Embodiment E is directed to a firefighting foam solution composition, the foam solution prepared by diluting any of the concentrates of the preceding Embodiments with water, wherein: water constitutes at least about 90 wt % of the composition; and the viscosity of the foam solution is at least about 10% greater than the viscosity of the concentrate diluted to form the composition.

Embodiment F is directed to a firefighting foam solution composition, the foam solution containing water and at least or about 0.5 wt %, 1 wt %, 2 wt %, 3 wt %, 4 wt %, 5 wt %, or 6 wt % of the foam concentrate of any of Embodiments A-D1.

Embodiment G is directed to a firefighting foam solution composition, the foam solution prepared by diluting any of the concentrates of Embodiments A-D1 with water at a dilution ratio (concentrate:water) of from 1:99 to 6:94.

Embodiment H is directed to a firefighting foam composition prepared from the any of the concentrates or solutions of the present Embodiments, wherein the foam composition exhibits one or more of the following properties under testing in accordance with UL-162: a 25% (quarter) drain time (QDT) of at least about 20 minutes; and/or a saltwater expansion of at least about 3; and/or a saltwater drain time of at least about 20 min; and/or a freshwater expansion of at least about 3; and/or a freshwater drain time of at least about 20 min; and/or an extinguishment of less than about 300 seconds; and/or a burn back of greater than about 300 seconds; and/or passage of the 1^{st} torch test; and/or passage of the 2^{nd} torch test.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that several objects of the invention are achieved and other advantageous results attained.

As various changes could be made in the above without departing from the scope of the invention, it is intended that all matter contained in the above description shall be interpreted as illustrative and not in a limiting sense.

1. A firefighting foam concentrate, the concentrate comprising:
a solvent selected from the group consisting of alkyl glycols, glycol ethers, and combinations thereof;
a surfactant component comprising one or more surfactants selected from the group consisting of sulfate surfactants, branched and/or linear ethoxylated sulfate surfactants, betaine surfactants, amine oxide surfactants, sultaine surfactants, ethoxylated alcohol surfactants, linear and/or branched C6-C16 alcohols, alkylpolyglucoside surfactants, and combinations thereof;
optionally, an inorganic salt; and
optionally, an organic salt; wherein:
the viscosity of the firefighting foam concentrate is less than about 200 centipoise (cP); and the viscosity of a firefighting foam solution containing the firefighting foam concentrate and at least 90 wt % water is 10% greater than the viscosity of the firefighting foam concentrate, the viscosity determined using a Brookfield viscometer using spindle #4 at 30 revolutions per minute (rpm); and/or
upon dilution of the firefighting foam concentrate to form a firefighting foam solution, the firefighting foam solution comprises a micellar composition comprising an aqueous phase and a micelle phase comprising surfactant molecules; and/or
the firefighting foam concentrate exhibits Newtonian behavior; and/or
the firefighting foam solution exhibits solution thickening behavior.

2. The firefighting foam concentrate of claim 1, the concentrate comprising:
a surfactant component comprising a sulfate surfactant, a branched and/or linear ethoxylated sulfate surfactant, a betaine surfactant, amine oxide surfactant and a sultaine surfactant; and
wherein the solvent is present in a concentration of at least about 0.1 wt %, or from about 0.1 wt % to about 10 wt %.

3. The firefighting foam concentrate of claim 2, wherein the concentrate comprises an inorganic salt selected from the group consisting of magnesium sulfate, magnesium nitrate, magnesium chloride, calcium chloride, and combinations thereof in a concentration of at least about 10 wt %.

4. The firefighting foam concentrate of claim 2, wherein a firefighting foam solution containing the firefighting foam concentrate and at least 90 wt % water exhibits a fresh water drain time of at least 900 seconds and a salt water drain time of at least 900 seconds.

5. The firefighting foam concentrate of claim 1, the concentrate comprising an inorganic salt selected from the group consisting of sodium sulfate, sodium chloride, magnesium sulfate, magnesium nitrate, magnesium chloride, calcium chloride, and combinations thereof, wherein the inorganic salt is present in a concentration of from about 5 wt % to about 20 wt %, or from about 16.5 wt % to about 18.5 wt %.

6. The firefighting foam concentrate of claim 1, the concentrate comprising:
a sulfate surfactant, a branched and/or linear ethoxylated sulfate surfactant, a betaine surfactant, a sultaine surfactant, linear and/or branched fatty alcohol, an ethoxylated alcohol surfactant and an alkylpolyglucoside surfactant; and
wherein the solvent is present in a concentration of from about 0.1 wt % to about 15 wt %, from about 4 wt % to about 10 wt %.

7. The firefighting foam concentration of claim 6, wherein the concentrate comprises an inorganic salt selected from the group consisting of magnesium sulfate, magnesium nitrate, magnesium chloride, calcium chloride, and combinations thereof.

8. The firefighting foam concentrate of claim 1, the concentrate comprising:
a solvent selected from the group consisting of alkyl glycols, glycol ethers, and combinations thereof, wherein the solvent is present at a concentration of from about 1 wt % to about 15 wt %, or from about 3 wt % to about 10 wt %; and
an anionic sulfate surfactant and an amphoteric betaine surfactant, wherein the sulfate surfactant is present at a concentration of from about 5 wt % to about 50 wt %, or from about 10 wt % to about 30 wt %; and the betaine surfactant is present at a concentration of from about 5 wt % to about 50 wt %, or from about 5 wt % to about 30 wt %.

9. The firefighting foam concentrate of claim 1, the concentrate comprising;
a solvent selected from the group consisting of glycols, alkyl glycols, glycol ethers, and combinations thereof, wherein the solvent is present at a concentration of from about 3 wt % to about 10 wt %, or from about 5 wt % to about 8 wt %;
an anionic sulfate surfactant and an amphoteric surfactant selected from a betaine surfactant, sultaine surfactant, or a combination thereof; and
an inorganic di-valent salt selected from the group consisting of magnesium nitrate, magnesium chloride, magnesium sulfate, calcium chloride, and combinations thereof, wherein the inorganic salt is present at a concentration of at least about 0.1 wt. %, or from about 10 wt % to about 30 wt %.

10. The concentrate of claim 9, wherein water is present in a concentration of from about 10 wt % to about 80 wt %, or from about 15 wt % to about 45 wt %.

11. The concentrate of claim 9, wherein the surfactant component comprises an anionic sulfate surfactant and an amphoteric sultaine surfactant, wherein the sulfate surfactant is present at a concentration of from about 5 wt % to about 50 wt % and the sultaine surfactant is present at a concentration of from about 15 wt % to about 50 wt %.

12. The concentrate of claim 9, the concentrate comprising:
an anionic sulfate surfactant and an amphoteric surfactant comprising a betaine surfactant and a sultaine surfactant, wherein:
the sulfate surfactant is present at a concentration of from about 10 wt % to about 20 wt %, or from about 14 wt % to about 17 wt %;
the betaine surfactant is present at a concentration of from about 5 wt % to about 40 wt %, or from about 12 wt % to about 20 wt %;
the sultaine surfactant is present at a concentration of from about 10 wt % to about 40 wt %, or from about 12 wt % to about 20 wt %;
the solvent is present at a concentration of from about 4 wt % to about 12 wt %, or from about 5 wt % to about 8 wt %; and
the inorganic salt is present at a concentration of at least about 10 wt %, or from about 17 wt % to about 25 wt %.

13. The concentrate of claim 9, the concentrate comprising:
a sulfate surfactant, a branched and/or linear ethoxylated sulfate surfactant, a betaine surfactant, and a sultaine surfactant, wherein:
the sulfate surfactant is present in a concentration of from about 2 wt % to about 12 wt %, or from about 4 wt % to about 8 wt %;
the branched and/or linear ethoxylated sulfate surfactant is present in a concentration of from about 1 wt % to about 7 wt %, or from about 3 wt % to about 6 wt %;
the betaine surfactant and sultaine surfactant are present in a concentration of from about 5 wt % to about 30 wt %, or from about 10 wt % to about 16 wt %; and
the inorganic salt is present in a concentration of up to about 25 wt %, or from about 10 wt % to about 20 wt %.

14. The firefighting foam concentrate of claim 9, the concentrate comprising:
a sulfate surfactant, a betaine surfactant, and a sultaine surfactant, wherein the betaine surfactant is present in a concentration of at least about 5 wt %, or from about 10 wt % to about 30 wt %; and
wherein a firefighting foam solution containing the firefighting foam concentrate and at least 90 wt % water exhibits a fresh water drain time of at least 900 seconds, or at least 1000 seconds and a salt water drain time of at least 900 seconds, or at least 1000 seconds.

15. The firefighting foam concentrate of claim 14, wherein the concentrate comprises:
a solvent selected from the group consisting of alkyl glycols, glycol ethers, and combinations thereof, wherein the solvent is present in a concentration of at least about 0.1 wt %, or from about 4 wt % to about 8 wt %.

16. A firefighting foam concentrate, the concentrate comprising:
a surfactant component comprising a C8-C12 sulfate surfactant, a C8-C12 branched and/or linear ethoxylated sulfate surfactant, or a combination thereof;
optionally, an inorganic salt; and
optionally, an organic salt, wherein:
the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or
upon dilution of the firefighting foam concentrate to form a firefighting foam solution, the firefighting foam solution comprises a micellar composition comprising an aqueous phase and a micelle phase comprising surfactant molecules and/or
the firefighting foam concentrate exhibits Newtonian behavior; and/or
the firefighting foam solution exhibits solution thickening behavior.

17. A firefighting foam concentrate, the concentrate comprising:
a solvent selected from the group consisting of alkyl glycols, glycol ethers, and combinations thereof;
a surfactant component comprising a C6-C16 amine oxide surfactant;
optionally, an inorganic salt; and
optionally, an organic salt; wherein:
the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or
upon dilution of the firefighting foam concentrate to form a firefighting foam solution, the firefighting foam solution comprises a micellar composition comprising an aqueous phase and a micelle phase comprising surfactant molecules; and/or
the firefighting foam concentrate exhibits Newtonian behavior; and/or
the firefighting foam solution exhibits solution thickening behavior.

18. A firefighting foam concentrate, the concentrate comprising:
a solvent selected from the group consisting of alkyl glycols, glycol ethers, and combinations thereof;
a surfactant component comprising a C6-C16 linear or branched fatty alcohol surfactant;
optionally, an inorganic salt; and
optionally, an organic salt; wherein:
the viscosity of the firefighting foam concentrate is less than about 200 centipoise (cP); and the viscosity of a firefighting foam solution containing the firefighting foam concentrate and at least 90 wt %. water is 10% greater than the viscosity of the firefighting foam concentrate; and/or
upon dilution of the firefighting foam concentrate to form a firefighting foam solution, the firefighting foam solution comprises a micellar composition comprising an aqueous phase and a micelle phase comprising surfactant molecules; and/or
the firefighting foam concentrate exhibits Newtonian behavior; and/or
the firefighting foam solution exhibits solution thickening behavior.

19. The firefighting foam concentrate of claim 18 wherein the surfactant is a C6 to C16 linear or branched alcohol selected from the group consisting of 3-methyl-3-pentanol (C6), 1-heptanol (enanthic alcohol) (C7), 1-octanol (capryl alcohol) (C8), pelargonic alcohol (1-nonanol) (C9), 1-decanol (decyl alcohol) (C10), undecyl alcohol (1-undecnaol) (C11), lauryl alcohol (dodecanol) (C12), tridecyl alcohol (1-tridecanol) (C13), myristyl alcohol (1-tetradecanol) (C14), pentadecyl alcohol (1-pentadecanol) (C15), cetyl alcohol (1-hexadeconaol) (C16), and combinations thereof.

20. A firefighting foam solution composition, the foam solution prepared by diluting the concentrate of claim 1 with water, wherein:
water constitutes at least about 90 wt % of the composition; and
the viscosity of the foam solution is at least about 10% greater than the viscosity of the concentrate diluted to form the composition.

21. A firefighting foam solution composition, the foam solution containing water and at least or about 0.5 wt %, 1 wt %, 2 wt %, 3 wt %, 4 wt %, 5 wt %, or 6 wt % of the foam concentrate of claim 1.

22. A firefighting foam solution composition, the foam solution prepared by diluting the concentrate of claim 1 with water at a dilution ratio (concentrate:water) of from 1:99 to 6:94.

23. A firefighting foam composition prepared from the concentrate of claim 1, wherein the foam composition exhibits one or more of the following properties under testing in accordance with UL-162:
a 25% (quarter) drain time (QDT) of at least about 20 minutes; and/or
a saltwater expansion of at least about 3; and/or
a saltwater drain time of at least about 20 min; and/or
a freshwater expansion of at least about 3; and/or
a freshwater drain time of at least about 20 min; and/or
an extinguishment of less than about 300 seconds; and/or
a burn back of greater than about 300 seconds; and/or
passage of the 1^{st} torch test; and/or
passage of the 2^{nd} torch test.
